(19) United States
(12) Patent Application Publication
(10) Pub. No.: US 2014/0169185 A1
(43) Pub. Date: Jun. 19, 2014

(54) METHOD FOR HANDOVER AT USER EQUIPMENT AND USER EQUIPMENT CONFIGURED TO HANDOVER

(71) Applicants: Ali MASOOMZADEH-FARD, Marlboro, NJ (US); Martin MEYERS, Montclair, NJ (US)

(72) Inventors: Ali MASOOMZADEH-FARD, Marlboro, NJ (US); Martin MEYERS, Montclair, NJ (US)

(21) Appl. No.: 13/713,308

(22) Filed: Dec. 13, 2012

(51) Int. Cl. H04W 36/08

(52) U.S. Cl. CPC H04W 36/08
USPC 370/252; 370/331

(57) ABSTRACT

The method for handover at user equipment includes decoding an information block from at least one of one or more target base stations before receiving a handover command indicating to handover to a first target base station and connecting to the first target base station using the decoded information block.

### BACKGROUND

1. Field

One or more example embodiments relate to handover at user equipment when selecting a base station for handover.

2. Description of the Related Art

The current method of handover for user equipment involves the user equipment requesting handover from the network, receiving a handover command indicating the target base station to connect to, and then decoding an information block from the target base station and connecting to the target base station using the decoded information block.

### SUMMARY

At least one example embodiment is directed to a method and/or apparatus for handover at user equipment.

According to at least one example embodiment, a method for handover at user equipment includes decoding an information block from at least one of a one or more target base stations before receiving a handover command indicating to handover to a first target base station and connecting to the first target base station using the decoded information block.

The method may include performing slot and frame timing synchronization with signals received from the at least one target base station.

The method may include identifying slot timing and radio frame timing from primary synchronization signals and secondary synchronization signals being transmitted by the at least one target base station and decoding the information block from the at least one target base station using the slot timing and radio frame timing.

The method may include determining the at least one target base station from one or more of neighboring base stations.

The determining may measure a signal strength of each of the one or more neighboring base stations, sort the one or more neighboring base stations based on the measured signal strengths and select n neighboring base stations as the at least one target base station, the n target base stations having the n strongest measured signal strengths, where n is a natural number.

The determining may measure a signal strength of each of the one or more neighboring base stations, sort the one or more neighboring base stations based on the measured signal strengths and select neighboring base stations with signal strength above a threshold as the at least one target base station.

The method may include sending a request for handover and receiving a handover command indicating the target base station with which to connect.

The method may include disconnecting from a source base station prior to connecting to the target base station.

The method may include disconnecting from a source base station after connecting to the target base station.

According to at least one example embodiment, user equipment may be configured to decode an information block from at least one of one or more target base stations before receiving a handover command indicating to handover to a first target base station, and connect to the first target base station using the decoded information block.

The user equipment may be configured to perform slot and frame timing synchronization with received signals from the at least one target base station.

The user equipment may be configured to (1) identify slot timing and radio frame timing from primary synchronization signals and secondary synchronization signals being transmitted by the at least one target base station and (2) decode the information block from the at least one target base station using the slot timing and radio frame timing.

The user equipment may be configured to determine the at least one target base station from one or more neighboring base stations.

The user equipment may be configured to measure a signal strength of each of the one or more neighboring base stations, sort the one or more neighboring base stations based on the measured signal strengths and select n neighboring base stations as the at least one target base station, the n target base stations having the n strongest measured signal strengths, where n is a natural number.

The user equipment may be configured to measure a signal strength of each of the one or more neighboring base stations, sort the one or more neighboring base stations based on the measured signal strengths and select neighboring base stations with signal strength above a threshold as the at least one target base station.

The user equipment may be configured to send a request for handover and receive a handover command indicating the first target base station with which to connect.

The user equipment may be configured to disconnect from a source base station prior to connecting to the target base station.

The user equipment may be configured to disconnect from a source base station after connecting to the target base station.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present invention, and wherein:

FIG. 1 illustrates s example of a wireless communication network 100, according to some example embodiments;

FIG. 2 is a diagram illustrating an example structure of user equipment 120, according to some example embodiments;

FIG. 3 is a flowchart illustrating a method for handover at user equipment when connecting to a base station, according to some example embodiments;

FIG. 4A is a flowchart illustrating an example of an order of connecting to a base station in the method of FIG. 3;

FIG. 4B is a flowchart illustrating an example of an order of connecting to a base station in the method of FIG. 3;

FIG. 5A is a flowchart illustrating an example of an operation of determining a target base station from one or more neighboring base stations 110 in the method of FIG. 3; and

FIG. 5B is a flowchart illustrating an example of an operation of determining a target base station from one or more neighboring base stations 110 in the method of FIG. 3.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given example embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings, in which some example embodiments are shown. Example embodiments may, however, be embodied in many different forms and should not be construed as being limited to the example embodiments set forth herein; rather, these example embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular example embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Portions of the present example embodiments and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Wireless communication networks typically include a plurality of base stations where one or more base stations serve a corresponding geographic area commonly referred to as a cell. Users of the wireless communication network use their user equipment to communicate with each other and/or with the wireless communication network. The user equipment may include but is not limited to user equipment (UE), a fixed or mobile subscriber unit, a pager, a personal digital assistant (FDA), a computer or any other type of user device capable of operating in a wireless environment.

As used herein, the term “user equipment” (UE) may be considered synonymous to, and may hereafter be occasionally referred to, as a phone, wirelessly equipped laptop, a mobile, mobile unit, mobile user, subscriber, user, remote station, access terminal, receiver, etc., and may describe a remote user of wireless resources in a wireless communication network. The term “base station” may be considered synonymous to and/or referred to as a base transceiver station (BTS), base station (BS), Node B, eNodeB, etc. and may describe equipment that provides data and/or voice connectivity between a network and one or more users.

The wireless communication network operates in accordance with established rules promulgated by governmental and industry groups. These rules establish standards with which wireless communication networks comply. The standards contain various protocols that dictate the operation of the wireless communication networks. Other proprietary rules may be provided for operation of the wireless communication network. A protocol is a set of rules in accordance with communication within a communication network is to be initiated, maintained and terminated. One of the standard systems for wireless communication in today's world is called long term evolution (LTE). In this system each base station is referred to as evolved node B (eNB). One or more cells can be covered by an eNB. The equipment at the base station is referred to as system equipment. In wireless communication systems, communication can occur between two user equipment or between user equipment and system equipment.

User equipment located in a particular cell being served by a base station communicates with other user equipment or with other communication networks via the base station. The signals from the user equipment are transmitted to receiving user equipment or to another communication network via the base station of the cell within which the user equipment is located. As the user equipment moves through cells being served by the same or different base stations, communication from the user equipment is handled by the same or different base stations. Communication for user equipment moving from one cell to another cell may be transferred from one base station to another base station if the two cells are covered by different base stations. Otherwise the communication for user equipment moving from one cell to another cell covered by the same base station may be transferred to another sector of the same base station. The process by which communication for the user equipment is transferred from one base station (for example, a source base station) to another base station (for example, an indicated base station) is known as a handover. The user equipment located at the edge of the source base station and near the indicated base station will request a handover to the indicated base station depending on the relative strength of the communication signals of neighboring base stations.

As is well-known in the art, each of user equipment and a base station may have transmission and reception capabilities. Transmission from the base station to the user equipment is referred to as downlink or forward link communication. Transmission from the user equipment to the base station is referred to as uplink or reverse link communication.

In many wireless communication networks, the base stations transmit pilot signals (also called reference signals) continuously and the user equipment measures the strength of these pilot signals. The user equipment may request a handover to one or more neighboring base stations based on the relative measured strength of the pilot signals. The wireless communication network can also trigger the handover procedure based on periodic measurement reports from the user equipment or for other reasons such as congestion in a cell to which the user equipment is connected. In order to measure the pilot signal of a neighboring base station, the user equipment performs slot and frame timing synchronization with received signals from the neighboring base station. This also provides the user equipment with the identity of the neighboring base station. At this point, the user equipment can start measuring the pilot signal of the neighboring base station.

In order to decode the information block of a base station, the user equipment must synchronize to a downlink of the base station. The base station broadcasts primary and secondary synchronization signals in each cell and transmits the signals periodically in each frame. The particular signals broadcast in each cell indicate a physical cell identification of that cell. The user equipment detects the primary and secondary synchronization signals to find slot and frame timing boundaries as well as frequency synchronization. The user equipment may also find the physical cell identification, cyclic prefix length and whether the cell uses Frequency Division Duplex (FDD) or Time Division Duplex (TDD). The user equipment synchronizes to the downlink in two steps. The user equipment first identifies the slot timing of the downlink, then determines the radio frame timing of the downlink. The frequency location and bandwidth of synchronization signals are fixed, independent of the system bandwidth. Thus, the user equipment may perform synchronization before knowing the system bandwidth. After the synchronization process is finished successfully, the user equipment may find the timing of a physical broadcast channel and decode the broadcast information.

If the user equipment determines that a target base station from the one or more neighboring base stations has stronger signal strength than the source base station, the user equipment may request a handover from the source base station, as is well-known in the art. The source base station receives the handover request and may indicate a target base station for handover. Alternatively, a Radio Network Controller (RNC) may indicate a target base station for handover.

The source base station may include radio and processing equipment that are able to communicate with the neighboring base stations and the user equipment. The source base station or radio network controller communicates the handover request to the indicated base station, which determines if the indicated base station has the requisite resources to serve the user equipment. If the indicated base station has the requisite resources (for example, transmit power, bandwidth, data rate), the source base station sends a handover command to the user equipment indicating that the indicated base station is ready to accept the user equipment. Typically, after the user equipment sends a handover request and receives the handover command, the user equipment starts decoding the broadcast information sent by the indicated base station, in order to establish connection with the indicated base station. This process may take some time, on the order of tens of milliseconds. For example, this process may take between 10 to 40 ms.

From the time the user equipment receives the handover command, the data transmission and reception between the user equipment and a wireless communication network is stopped until the user equipment is connected to the indicated base station. This time period is called an interruption time of the handover. One of the quality metrics of the wireless communications network is to keep this time period as small as possible to avoid a bad user experience during a call, especially for real time applications such as voice calls. One of the reasons for an increase in interruption time is the time the user equipment takes to decode the broadcast information sent by the indicated base station after the user equipment receives the handover command.

While an interruption time is only present in a hard handover, example embodiments apply to soft handovers as well. Hard handover occurs when user equipment 120 only communicates to a single base station 110 at a time. This requires that the user equipment 120 disconnect from a first base station 110 prior to connecting to a second base station 110. Soft handover occurs when the user equipment 120 can communicate to multiple base stations 110 at a time, allowing the user equipment 120 to connect to the second base station 110 prior to disconnecting from the first base station 110.

After successful attachment to the indicated base station, the user equipment sends a confirmation message to the indicated base station confirming that the user equipment's communication with the indicated base station is established. The user equipment measurement report and other messages conveyed between the user equipment, source base station, target base stations and a mobility management entity (MME) during the handover procedure or immediately prior to handover are messages associated with a handover.

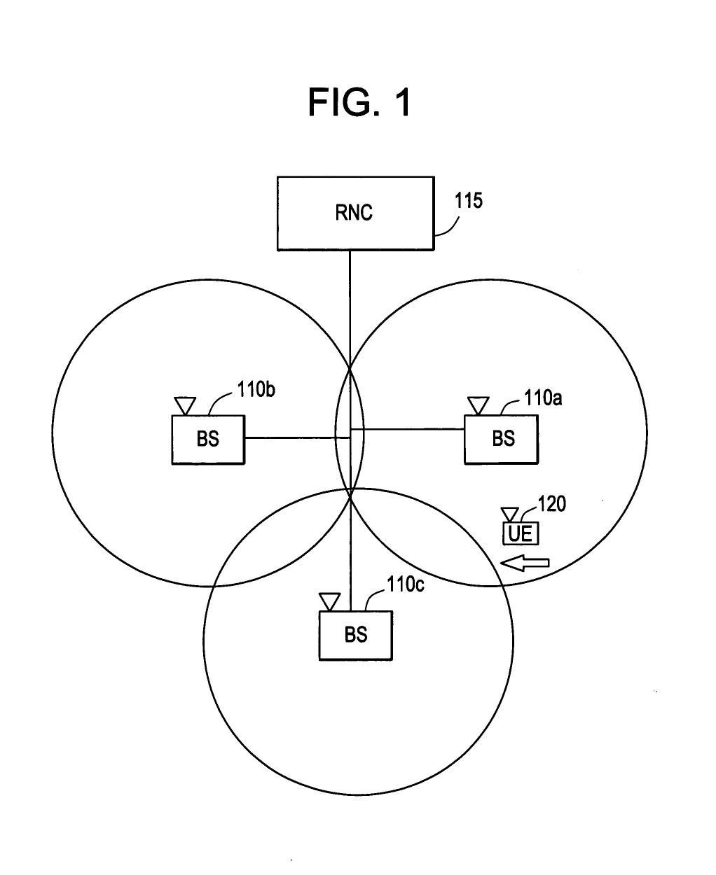

FIG. 1 illustrates an example of a wireless communication network 100, according to some example embodiments. In FIG. 1, the wireless communication network 100 includes a plurality of base stations 110 and a Radio Network Controller 115.

As shown in FIG. 1, base stations 110 are configured to provide wireless connectivity to one or more user equipment 120. For example, FIG. 1 illustrates a source base station 110a and neighboring base stations 110b and 110c. There may be additional base stations (not shown) in the wireless communication. A source base station 110 is a base station to which the user equipment is currently assigned for communication. Other than the source base station 110, any base station 110 that is in range of user equipment 120 is considered a neighboring base station 110. To determine if a base station 110 is in range, the user equipment may receive a signal from the base station 110 and determine if the signal strength is above a threshold. For example, neighboring base stations 110b and 110c have a signal strength above a threshold in FIG. 1, but there may be other base stations 110 (not shown) that have a signal strength below a threshold. Of the neighboring base stations 110, the user equipment 120 may select one or more target base stations 110 for handover according to communication protocols known in the art. The user equipment 120 may select a single target base station, but example embodiments are not limited thereto. For example, the user equipment 120 may select two or more base stations as target base stations 110. Alternatively, the user equipment 120 may determine that there are no target base stations 110 in range of the user equipment 120.

The source and neighboring base stations 110 are configured to provide wireless connectivity to one or more user equipment 120. Further, the source base station 110 and neighboring base stations 110 are configured to communicate with each other. For example, the source base station 110 and neighboring base stations 110 are configured to exchange information regarding their respective loading such as loading updates, configuration changes and handover messages for incoming handover evaluation. However, the wireless communication network 100 is not limited to illustrated base stations 110 in order to provide wireless connectivity. For example, the wireless communication network 100 may use or include additional base stations and other devices to provide wireless connectivity, such as base transceiver stations, base station routers, WiMAX or WiFi access points, access networks and the like.

While the wireless communication network 100 is only shown to explain handover of a single user equipment 120 for the sake of simplicity, it will be understood that example embodiments may handover one or more user equipment 120 simultaneously from a single source base station 110. Further, while only a single source base station 110 is discussed in the example described above, example embodiments may include one or more source base stations 110 in the wireless communication network 100.

The source base station 110 may be configured to receive measurement reports and loads of the one or more of neighboring base stations 110. The source base station 110 may be configured to select an indicated base station 110 from the one or more neighboring base stations 110 for handover of the user equipment 120 in any well-known manner. Alternatively, a radio network controller 115 may be configured to receive measurement reports and loads of the one or more neighboring base stations 110 and the radio network controller 115 may be configured to select an indicated base station 110 from the one or more neighboring base stations 110 for handover of the user equipment 120 n any well-known manner. The indicated base station may also be a target base station 110, but example embodiments are not limited thereto. For example, the indicated base station 110 may be one of the one or more neighboring base stations 110 that is not a target base station 110.

As discussed above, a wireless communications network 100 may include a plurality of base stations 110. Of the plurality of base stations 110, a source base station is the base station to which the user equipment is currently assigned for communication. Other than the source base station 110, any base station 110 that is in range of user equipment 120 is a neighboring base station 110. Of one or more neighboring base stations 110, the user equipment 120 may select one or more target base stations. Of the one or more neighboring base stations 110, the radio network controller 115 may select an indicated base station 110 for handover of the user equipment 120. The indicated base station 110 may be included in the one or more target base stations 110, or the indicated base station 110 may be a neighboring base station 110 that is not included in the one or more target base stations 110.

The measurement reports may be received from the user equipment 120 and include at least a signal-to-noise ratio (SNR) of the one or more neighboring base stations 110. The loads may be received from the one or more neighboring base stations 110 and be based on, for example, a number of user equipment being served by a base station 110, an available bandwidth of the base station 110, etc. The selection of the indicated base station 110 from the one or more neighboring base stations 110 can be done in any well-known manner and will not be described in detail.

One or more of the source base station 110, the neighboring base stations 110, the target base stations 110 and the indicated base station 110 include a processor (not shown) and a memory (not shown), which may store data and/or programs for use with the processor in order to process data or control information related to the user equipment 120, the source base station 110 and/or the neighboring base stations 110. The memory may, for example, include any type of computer storage mediums such as Read Only Memory (ROM) and/or Read Access Memory (RAM).

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other transitory and non-transitory mediums capable of storing, containing or carrying instruction(s) and/or data.

Furthermore, example embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

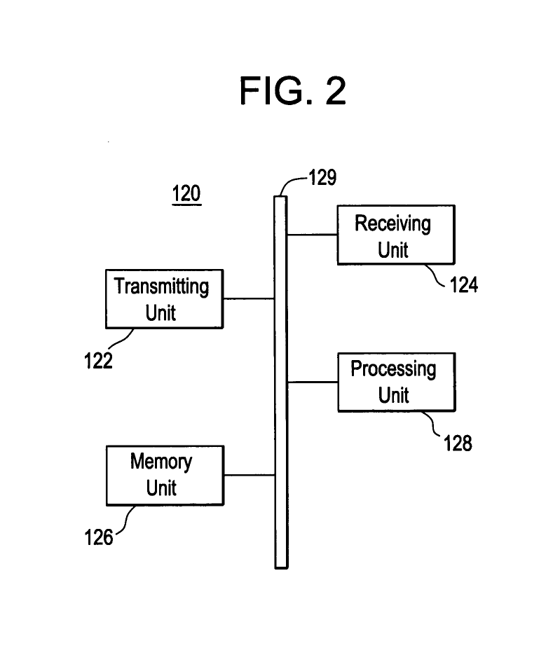

FIG. 2 is a diagram illustrating an example structure of user equipment 120, according to some example embodiments. In FIG. 2, the user equipment 120 may include, for example, a transmitting unit 122, a receiving unit 124, a memory unit 126 and a processing unit 128 that are connected by a data bus 129.

The transmitting unit 122, receiving unit 124, memory unit 126, and processing unit 128 may send data to and/or receive data from one another using the data bus 129. The transmitting unit 122 is a device that includes hardware and any necessary software for transmitting wireless signals including, for example, data signals, control signals, and signal strength/quality information via one or more wireless connections to other network elements in the wireless communication network 100.

The receiving unit 124 is a device that includes hardware and any necessary software for receiving wireless signals including, for example, data signals, control signals, and signal strength/quality information via one or more wireless connections to other network elements in the wireless communications network 100. The transmitting unit 122 may transmit signals to the source base station 110 and/or the neighboring base stations 110, while the receiving unit 124 may receive signals from the source base station 110 and/or the neighboring base stations 110.

The memory unit 126 may be any device capable of storing data including magnetic storage, flash storage, etc.

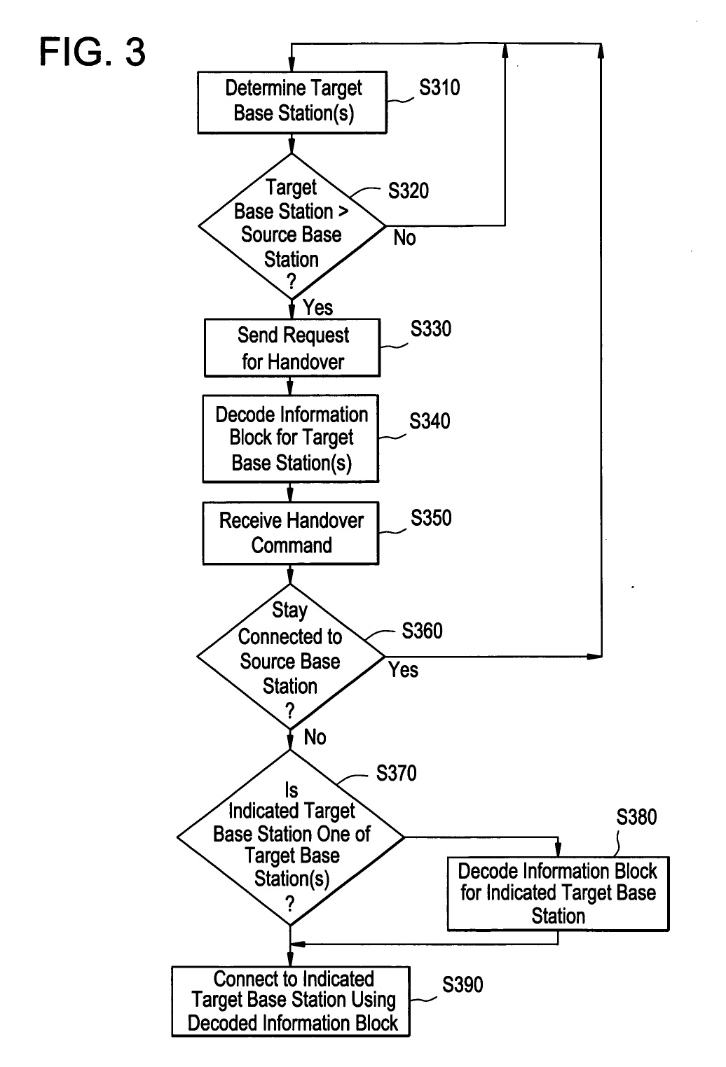

The processing unit 128 may be any device capable of processing data including, for example, a microprocessor configured to carry out specific operations based on input data, or capable of executing instructions included in computer readable code. For example, the processing unit 158 may be configured to be programmed to operate like the user equipment 120 in FIG. 1 and the memory unit 156 may be configured to store the program. The operation of the user equipment 120 will be described in greater detail below with reference to FIG. 3.

FIG. 3 is a flowchart illustrating a method for handover at user equipment when connecting to a base station, according to some example embodiments.

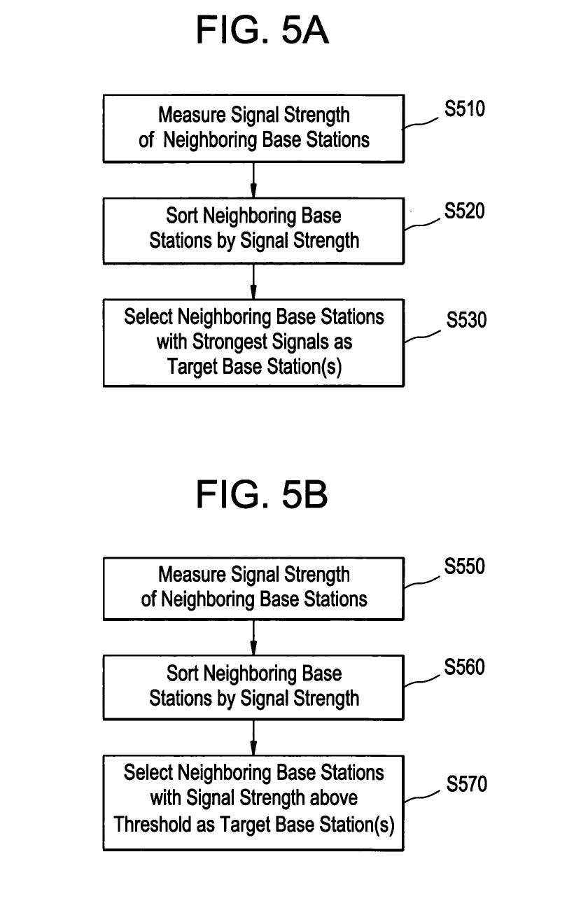

The user equipment in FIG. 3 may be the user equipment 120 shown in FIG. 1. At S310 in FIG. 3, the user equipment 120 determines one or more target base stations 110 from the one or more neighboring base stations 110. The step of determining one or more target base stations 110 will be described in greater detail below with regard to FIGS. 5A and 5B.

At S320, the user equipment 120 determines if the one or more target base stations have signal strengths greater than the source base station 110. If the one or more target base stations do not have signal strengths greater than the source base station, the user equipment 120 may remain connected to the source base station 110. If the user equipment 120 determines that it should remain connected to the source base station 110, the user equipment 120 repeats the step of determining one or more target base stations 110. The step of determining one or more target base stations 110 can be a discrete step concluded before beginning S320 or the step of determining one or more target base stations 110 can be done concurrently with S320-S350.

If the user equipment 120 determines the one or more target base stations 110 have signal strengths greater than the source base station, the method proceeds to S330.

In S330, the user equipment 120 may send a trigger to the source base station 110 to initiate a handover. For example, the user equipment 120 may request a handover from the source base station 110 to the one or more target base stations 110 according to communication protocols known in the art. While waiting for confirmation of the handover, the user equipment 120 proceeds to S340.

At S340, the user equipment 120 decodes an information block from each of the one or more target base stations 110. As described above in greater detail, to decode the information block, the user equipment 120 must synchronize to a downlink of the base station. The user equipment 120 decodes an information block for the one or more target base station 110 before receiving a handover command from the source base station 110.

At S350, the user equipment 120 receives the handover command from the source base station 110 indicating either to remain connected to the source base station 110 or to connect to an indicated base station 110 of the one or more neighboring base stations 110. The source base station 110 or radio network controller 115 may select the indicated base station 110 from the one or more neighboring base stations 110 based on the measurement reports and the loads of the one or more neighboring base stations 110. The indicated base station 110 may be one of the one or more target base stations 110. However, if the source base station 110 or radio network controller 115 determines that no neighboring base station 110 can accept the user equipment 120 for handover, the user equipment 120 remains connected to the source base station 110.

If the source base station 110 or radio network controller 115 selects the indicated base station 110, the source base station 110 or radio network controller 115 may send a request to the indicated base station 110 for handover of the user equipment 120. If the indicated base station accepts the request, the source base station 110 may send a handover command to the user equipment 120 indicating the indicated base station 110. If the indicated base station 110 denies the source base station's 110 request, the user equipment 120 remains connected to the source base station 110.

At S360, the user equipment 120 determines if the user equipment will remain connected to the source base station 110 or if the handover command directs the user equipment 120 to connect to one of the one or more neighboring base stations 110. If the user equipment 120 is to remain connected to the source base station 110, the user equipment proceeds to S310. If the handover command directs the user equipment to connect to an indicated base station 110, the user equipment 120 prepares for handover according to communication protocols known in the art and the method proceeds to S370.

At 370, the user equipment determines if the indicated base station 110 is one of the one or more target base stations 110. If the user equipment determines that the indicated base station 110 is one of the one or more target base stations 110 for which an information block was decoded in S340, the method proceeds to S390. If the user equipment determines that the indicated base station is not a target base station 110, the method proceeds to S380. At S380, the user equipment 120 decodes an information block for the indicated base station 110 before proceeding to S390. At S390, the user equipment 120 connects to the indicated base station using the decoded information block acquired in S340 or S380, according to communication protocols known in the art.

By decoding the information blocks from each of the one or more target base stations 110 in S340, the user equipment 120 is removing delay caused by having to decode the information block after receiving the handover command. As an example, decoding the information blocks before receiving a handover command from the source base station 110 may eliminate an interruption time of between 10 and 40 ms, as compared to decoding the information block after receiving the handover command.

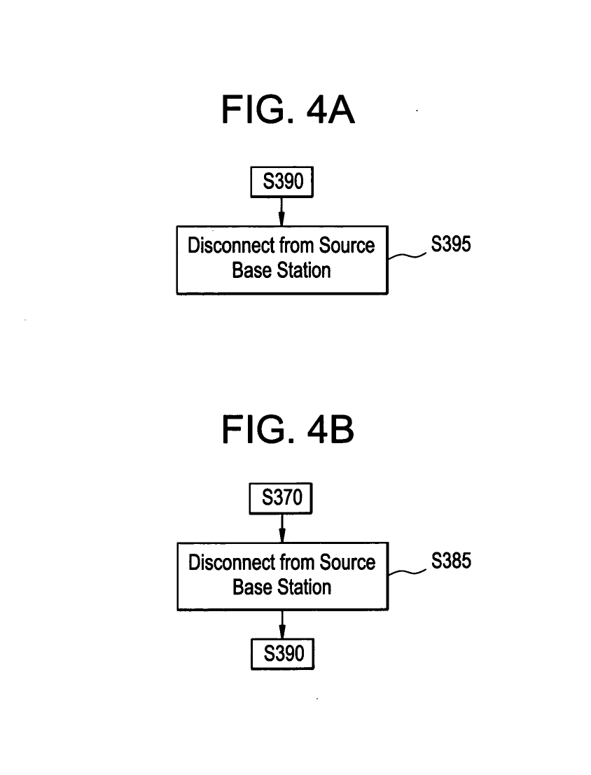

FIG. 4A is a flowchart illustrating an example of an order of connecting to a base station in the method of FIG. 3. As illustrated in FIG. 4A, the user equipment 120 may connect to the indicated base station 110 at S390 prior to disconnecting from the source base station 110 at S395. This is known as a soft handover.

FIG. 4B is a flowchart illustrating an example of an order of connecting to a base station in the method of FIG. 3. As illustrated in FIG. 4B, the user equipment 120 may connect to the indicated base station 110 at S390 after disconnecting from the source base station 110 at S385. This is known as a hard handover.

FIG. 5A is a flowchart illustrating an example of an operation of determining one or more target base stations 110 from one or more neighboring base stations 110 in the method of FIG. 3. At S510, the user equipment 120 measures or obtains signal strength of each of the one or more neighboring base stations. At S520, the user equipment sorts the one or more neighboring base stations 110 based on the signal strength measured in S510. At S530, the user equipment 120 selects n neighboring base stations 110 with the n strongest signals as the one or more target base stations 110, where n is a natural number equal to or greater than one.

In another example embodiment, the user equipment 120 may determine n target base stations 110 of the one or more neighboring base stations 110, the n target base stations having the n strongest measured signal strength, where n is a natural number. For example, the user equipment 120 may determine three target base stations 110 with the three strongest measured signal strengths of the neighboring base stations 110. After selecting the three target base stations 110, the user equipment 120 may decode an information block from each of the three target base stations 110. If the handover command directs the user equipment 120 to connect to any of the three target base stations, the user equipment 120 has already decoded the information block and can connect to the selected target base station 120 with a reduced delay time.

FIG. 5B is a flowchart illustrating an example of an operation of determining one or more target base stations 110 from one or more neighboring base stations 110 in the method of FIG. 3.

At S550, the user equipment 120 measures or obtains signal strengths of each of the one or more neighboring base stations. At S560, the user equipment sorts the one or more neighboring base stations 110 based on the signal strength measured in S550. At S570, the user equipment 120 selects each neighboring base station 110 with signal strength above a threshold as the one or more target base stations 110.

The threshold may be determined empirically or based on specifications for the one or more neighboring base stations 110. For example, the threshold may be set such that each of the one or more neighboring base stations 110 having a measured signal strength below a certain amount is excluded from consideration. The remaining base stations of the one or more neighboring base stations 110 may be selected as the one or more target base stations 110.

Alternatively, the threshold may be set such that neighboring base stations 110 having a measured signal strength below a certain percentage of the strongest measured signal strength may be excluded from consideration. For example, the threshold may be set to 50% so that neighboring base stations 110 having a measured signal strength below 50% of the strongest measured signal are excluded from consideration. As an example, the signal strength may be measured by a signal-to-noise ratio (SNR). For example, the user equipment 120 may rank the one or more neighboring base stations 110 according to the SNR ratio of the one or more neighboring base stations 110. After selecting the one or more target base stations 110 having a measured signal strength above the threshold, the user equipment 120 may decode an information block from each of the one or more target base stations 110. If the handover command directs the user equipment 120 to connect to any of the one or more target base stations 110, the user equipment 120 has already decoded the information block and can connect to the indicated base station 110 with a reduced delay time.

While example embodiments have been particularly shown and described, it will be understood by one of ordinary skill in the art that variations in form and detail may be made therein without departing from the spirit and scope of the claims.

What is claimed is:

1. A method for handover at user equipment, comprising:
decoding an information block from at least one of one or more target base stations before receiving a handover command indicating to handover to a first target base station; and
connecting to the first target base station using the decoded information block.

2. The method of claim 1, wherein the decoding performs slot and frame timing synchronization with signals received from each of the one or more target base stations.

3. The method of claim 1, wherein the decoding includes,
identifying slot timing and radio frame timing from primary synchronization signals and secondary synchronization signals being transmitted by the at least one of the one or more target base stations; and
decoding the information block from the at least one of the one or more target base stations using the slot timing and radio frame timing.

4. The method of claim 1, further comprising:
determining the at least one of the one or more target base stations from one or more neighboring base stations.

5. The method of claim 4, wherein the determining further comprises:
measuring a signal strength of each of the one or more neighboring base stations;
sorting the one or more neighboring base stations based on the measured signal strengths; and
selecting n neighboring base stations as the at least one of the one or more target base stations, the n target base stations having the n strongest measured signal strengths, where n is a natural number.

6. The method of claim 4, wherein the determining further comprises:
measuring the signal strength of each of the one or more neighboring base stations;
sorting the one or more neighboring base stations based on the measured signal strengths; and
selecting neighboring base stations with signal strength above a threshold as the at least one of the one or more target base stations.

7. The method of claim 1, further comprising:
sending a request for handover; and
receiving a handover command indicating the first target base station with which to connect.

8. The method of claim 1, further comprising:
disconnecting from a source base station prior to connecting to the first target base station.

9. The method of claim 1, further comprising:
disconnecting from a source base station after connecting to the first target base station.

10. User equipment configured to,
decode an information block from at least one of one or more target base stations before receiving a handover command indicating to handover to a first target base station, and
connect to the first target base station using the decoded information block.

11. The user equipment of claim 10, wherein the user equipment is configured to perform slot and frame timing synchronization with received signals from each of the one or more target base stations.

12. The user equipment of claim 10, wherein the user equipment is configured to (1) identify slot timing and radio frame timing from primary synchronization signals and secondary synchronization signals being transmitted by the at least one of the one or more target base stations and (2) decode the information block from the at least one of the one or more target base stations using the slot timing and radio frame timing.

13. The user equipment of claim 10, wherein the user equipment is configured to determine the at least one target base station from one or more neighboring base stations.

14. The user equipment of claim 10, wherein the user equipment is further configured to measure a signal strength of each of the one or more neighboring base stations, sort the one or more neighboring base stations based on the measured signal strengths and select n neighboring base stations as the at least one target base station, the n target base stations having the n strongest measured signal strengths, where n is a natural number.

15. The user equipment of claim 10, wherein the user equipment is further configured to measure a signal strength of each of the one or more neighboring base stations, sort the one or more neighboring base stations based on the measured signal strengths and select neighboring base stations with signal strength above a threshold as the at least one target base station.

16. The user equipment of claim 10, wherein the user equipment is configured to send a request for handover and receive a handover command indicating the first target base station with which to connect.

17. The user equipment of claim 10, wherein the user equipment is configured to disconnect from a source base station prior to connecting to the first target base station.

18. The user equipment of claim 10, wherein the user equipment is configured to disconnect from a source base station after connecting to the first target base station.
